(19) United States
(12) Patent Application Publication
(10) Pub. No.: US 2023/0214889 A1
(43) Pub. Date: Jul. 6, 2023

(54) Business feedback system

(71) Applicants: Hung-Che Chu, Kaohsiung (TW); En-Kai Chu, Kaohsiung (TW); Ching-Jou Chu, Kaohsiung (TW)

(72) Inventors: Hung-Che Chu, Kaohsiung (TW); En-Kai Chu, Kaohsiung (TW); Ching-Jou Chu, Kaohsiung (TW)

(21) Appl. No.: 17/822,121

(22) Filed: Aug. 24, 2022

(30) Foreign Application Priority Data
Jan. 6, 2022 (TW) 111200142

(51) Int. Cl. G06Q 30/02

(52) U.S. Cl. CPC G06Q 30/0282; G06Q 30/0217; G06Q 30/0203; G06Q 30/0201

(57) ABSTRACT

A system for business feedback includes a first feedback recipient feedback module, a system operation module, a cash flow module, and a supply module. The feedback recipient feedback module includes an initialization unit for receiving personal data and a recommendation unit connected to the first initialization unit for receiving recommendation data. The system operation module receives feedback information from the recommendation unit and collects cash flow information or gift information which is sent to the cash flow module or the supply module. The system operation module can increase the number of the first feedback recipient feedback module connected thereto based on records of recommendation information. The cash flow module receives the cash flow information and sends feedback money to the user of the first feedback recipient feedback module. The supply module receives the gift information from the system operation module and send gifts to the user.

### FIELD OF THE INVENTION

The invention relates to business feedback and more particularly to a business feedback system having improved characteristics.

### BACKGROUND OF THE INVENTION

Recently, many business models have a business feedback system for benefitting users. A user may operate the business feedback system to get a proportional feedback. Thus, many users would buy more products because they can get feedback money or gifts.

However, the conventional business feedback system has the following disadvantages:

High risk. With respect to the conventional business feedback system, a user has to pay a relatively high fee in use. Also, it is difficult of getting proportional feedback. Further, paid fee can be not refund if the user desires to get it back. It has high risk.

Only a small percentage of users can get corresponding feedback. In short, very few users have benefit. And in turn, more and more people decide to leave the system.

Thus, the need for improvement still exists.

### SUMMARY OF THE INVENTION

It is therefore one object of the invention to provide a business feedback system comprising a first feedback recipient feedback module, a system operation module, a cash flow module, and a supply module wherein the first feedback recipient feedback module is connected to the system operation module, the cash flow module, and the supply module respectively and includes a first initialization unit for receiving personal data of a user, and a first recommendation unit connected to the first initialization unit for receiving recommendation data of the user; the system operation module is connected to the first feedback recipient feedback module, the cash flow module, and the supply module respectively and configured to receive feedback information from the first recommendation unit and collect cash flow information or gift information which is sent to the cash flow module or the supply module; the system operation module is configured to increase the number of the first feedback recipient feedback module connected thereto based on records of recommendation information; the cash flow module is connected to the first feedback recipient feedback module and the system operation module respectively so that the cash flow module is configured to receive the cash flow information from the system operation module and send feedback money to the user of the first feedback recipient feedback module; and the supply module is connected to the first feedback recipient feedback module and the system operation module respectively so that the supply module is configured to receive the gift information from the system operation module and send gifts to the user of the first feedback recipient feedback module.

Preferably, the gifts are health food or coupons.

Preferably, there is further comprised of a period reset module connected to the business feedback system for setting a predetermined period of time prior to inactivating the business feedback system, and after the predetermined period of time has lapsed, the business feedback system resumes operation.

Preferably, there is further comprised of at least one second feedback recipient feedback module wherein the number of the at least one second feedback recipient feedback module is based on the number of the records of recommendation information, the at least one second feedback recipient feedback module is connected to the system operation module, the cash flow module, and the supply module respectively, and each of the at least one second feedback recipient feedback module includes a second initialization unit for receiving personal data of the user, and a second recommendation unit connected to the second initialization unit for receiving recommendation data of the user.

The invention has the following advantages and benefits in comparison with the conventional art:

Low risk includes zero risk, success guarantee, low cost, great benefit and short period. The cash flow module may refund the paid fee to the user if the recommendation does not send four records of recommendation information in a set period of time. There is no loss for the user, i.e., very low risk.

Continuous gifts given and feedback money paid (i.e., double benefit). A user may invite many recommenders to join the invention and each recommender may invite other potential recommenders to join the invention. A recommendation associated with the recommender and a recommendation associated with the user are interconnected. The total number of records of recommendation information associated with a user is increased greatly due to continuous recommendation. And in turn, feedback money is paid and gifts are given continuously.

Short period including low cost, great benefit, short period of time, fixed period and reliable expectation. The recommendation sends feedback information to the system operation module if the count of sent records of recommendation information has been reached in a set period of time. Either a user or a recommender may try to reach that goal. And in turn, a feedback mechanism is carried out. That is, feedback time is based on the set period of time and in turn the user may expect a desire feedback. This feedback is quick, can be expected, and is great.

Maximum feedback (i.e., accumulated feedback). Feedback information can be generated and sent to the system operation module if count of the sent records of recommendation information has been reached by a recommender or a user in a set period of time. As a result, accumulated feedback is fulfilled.

Automatic feedback after a period of time (i.e., system operation without organization). A user can easily operate the invention to recommend a recommender to use the invention so that the recommender may operate the invention in a similar way. The recommendation of the recommender and the recommendation of the user are interconnected. Thus, the total number of records of recommendation information associated with a user is increased greatly due to continuous recommendation of new recommenders. If the user does not do recommendation, a recommender still can have feedback by recommendation. Thus, the user still have feedback without operating the invention by himself or herself after operating the invention for a period of time.

Setting end of feedback (i.e., great economic cycle). The period reset module 15 can set a period of time as end of the invention (i.e., inactivating the business feedback system). After the set period of time has lapsed, the business feedback system resumes operation. All operation information stored in the system operation module will be reset when the business feedback system resumes operation. This can prevent feedback from becoming excessively large.

Health and common wealth. Gifts given by the cash flow module can be health food (preferred) or coupons. Thus, a user of the invention has health food. Also, a consumer has feedback money. Therefore, more users have a chance of having both health and wealth.

Maximum feedback. Recommendation information of users, recommenders and potential recommenders including feedback information and gift information can be sent to the cash flow module and the supply module via the system operation module respectively. And in turn, the cash flow module pays feedback money to the user and the supply module gives gifts to the user respectively.

Inheritor feedback is guaranteed. The business feedback system of the invention may be inoperable if a user is dead. An inheritor of the user may receive feedback money paid by the cash flow module or gifts given by the supply module for a period of time. The system operation module may respectively send cash flow information to the cash flow module and gift information to the supply module based on the cash flow information and the gift information generated by the first feedback recipient feedback module prior to the user's death. The cash flow module may pay feedback money to the inheritor and the supply module may give gifts to the inheritor respectively for a period of time.

Multifunction. The invention provides low price purchase, investment and financial management, saving and life insurance to users.

The above and other objects, features and advantages of the invention will become apparent from the following detailed description taken with the accompanying drawings

### BRIEF DESCRIPTION OF THE DRAWINGS

FIG. 1 is a block diagram of a business feedback system of the invention;

FIG. 2 schematically depicts a plurality of first initialization units added together; and

FIG. 3 is a block diagram of the business feedback system incorporating a period reset module.

### DETAILED DESCRIPTION OF THE INVENTION

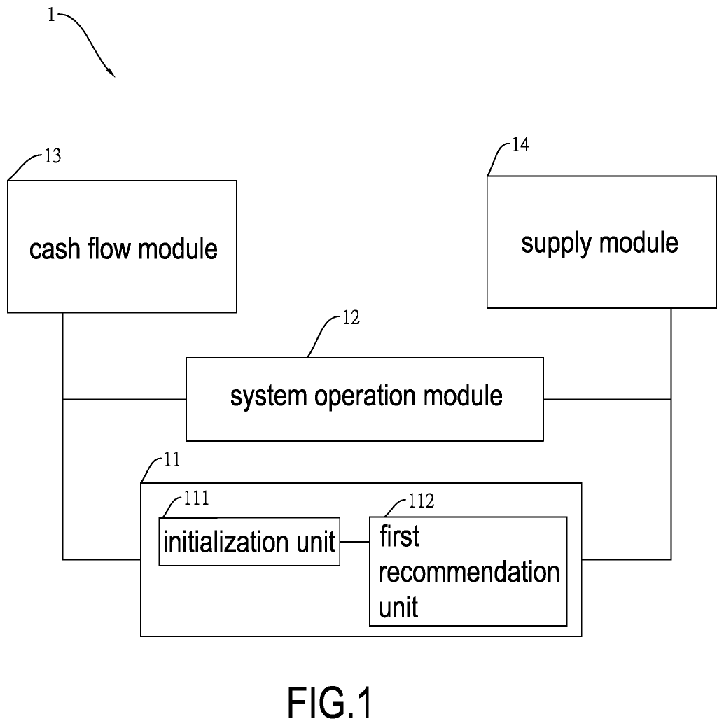

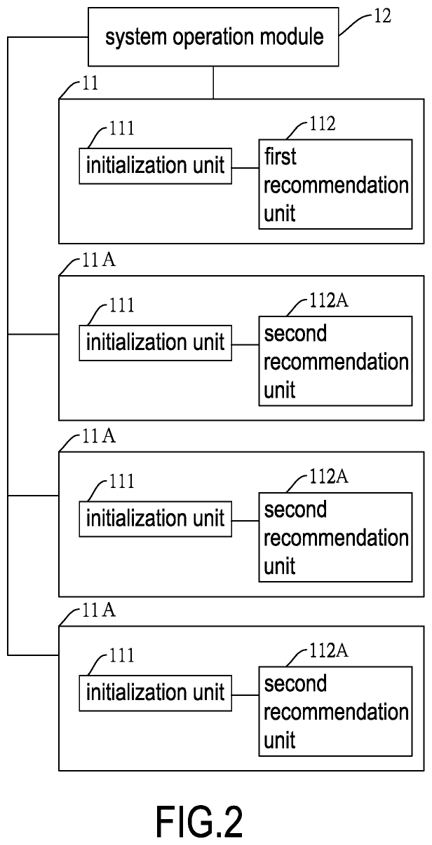

Referring to FIGS. 1 to 2, a business feedback system 1 of the invention comprises a first feedback recipient feedback module 11, a system operation module 12, a cash flow module 13 and a supply module 14 as discussed in detail below.

The first feedback recipient feedback module 11 is connected to the system operation module 12, the cash flow module 13 and the supply module 14 respectively and includes an initialization unit 111, and a first recommendation unit 112 connected to the initialization unit 111. The recommendation data can be personal information of a recommender.

A user may input personal data into the initialization unit 111. After the user has paid a set fee, the initialization unit 111 converts the personal data to user information which is in turn sent to the system operation module 12. The user may input data of at least one recommender to the first recommendation unit 112. The first recommendation unit 112 then converts the recommendation data to records of recommendation information and sends the records of recommendation information to the system operation module 12. The first recommendation unit 112 may set a count of the sent records of recommendation information. If the count has been reached, the first recommendation unit 112 sends feedback information to the system operation module 12.

The cash flow module 13 may refund the paid fee to the user if the first recommendation unit 112 does not send records of recommendation information in a set period of time. Next, the first feedback recipient feedback module 11 disconnects from the system operation module 12, the cash flow module 13 and the supply module 14. It means there is no loss for the user since the paid fee has been refunded to the user. In comparison with the conventional art, risk of operating the invention is greatly decreased.

The system operation module 12 is connected to the first feedback recipient feedback module 11, the cash flow module 13 and the supply module 14 respectively. The system operation module 12 can receive feedback information from the first recommendation unit 112 and collect cash flow information or gift information which is in turn sent to the cash flow module 13 or the supply module 14. The cash flow information is converted to feedback money based on personal information and the gift information is converted to gifts based on the number of sent records of recommendation information respectively. Finally, the system operation module 12 sends the cash flow information to the cash flow module 13 and the gift information to the supply module 14 respectively. One or more second feedback recipient feedback modules 11A can be connected to the system operation module 12 based on the number of records of recommendation information.

The cash flow module 13 is connected to the first feedback recipient feedback module 11 and the system operation module 12 respectively so that the cash flow module 13 can receive the cash flow information from the system operation module 12 and send feedback money to each user of the first feedback recipient feedback module 11.

The supply module 14 is connected to the first feedback recipient feedback module 11 and the system operation module 12 respectively so that the supply module 14 can receive gift information from the system operation module 12 and send same to each user of the first feedback recipient feedback module 11.

Gifts given by the supply module 14 can be health food (preferred) or coupons.

By utilizing the invention, a user may input personal data into the initialization unit 111. After the user has paid a set fee, the initialization unit 111 converts the personal data to user information which is in turn sent to the system operation module 12. The user may input data of at least one recommender to the first recommendation unit 112. The first recommendation unit 112 then converts the recommendation data to records of recommendation information and sends the records of recommendation information to the system operation module 12. The first recommendation unit 112 may set a count of the sent records of recommendation information. If the count has been reached in a set period of time, the first recommendation unit 112 may send feedback information to the system operation module 12. The system operation module 12 can receive feedback information from the first recommendation unit 112 and collect cash flow information or gift information which is in turn sent to the cash flow module 13 or the supply module 14. The cash flow information is converted to feedback money based on personal information and the gift information is converted to gifts based on the number of sent records of recommendation information respectively. Finally, the system operation module 12 sends the cash flow information to the cash flow module 13 and the gift information to the supply module 14 respectively.

It is envisaged by the invention that more feedback money or gifts will be if there are more recommenders. And in turn, the cash flow module 13 sends the feedback money to each user of the first feedback recipient feedback module 11 and the supply module 14 sends the gifts to each user of the first feedback recipient feedback module 11 respectively. A great feedback effect is brought about.

Preferably, the count of the sent records of recommendation information is four. If the count has reached four, the first recommendation unit 112 may send feedback information to the system operation module 12. That is, the number of the first feedback recipient feedback module 11 is four. Each added second feedback recipient feedback module 11A is connected to the system operation module 12. Four recommenders are thus provided. The first recommendation unit 112 sends the feedback information to the system operation module 12.

In practice, a user may confirm whether the number of recommenders has reached the count in a set period of time prior to using the invention. Next, the user may charge a set fee to each recommender who desires to the use the invention and the recommender is required to pay the fee when inputting personal data into the initialization unit 111. After the user has confirmed that the number of recommenders has reached a set count, the user may input personal data of each recommender to the initialization unit 111 and pay the required fee. Also, the user sends data of at least one recommender to the first recommendation unit 112. The first recommendation unit 112 then converts the recommendation data to records of recommendation information and sends the records of recommendation information to the system operation module 12. The first recommendation unit 112 may set a count of the sent records of recommendation information. Next, the user sends data of a predetermined number of recommenders to the first recommendation unit 112. Thus, fee paid by each recommender associated with a user who does not have required number of recommenders can be refunded by the user. The invention only feedbacks to each recommender and associated user who has the required number of recommenders in a set period of time. Fees collected by a user who does not have the required number of recommenders are kept by the user.

The recommender may send records of recommendation information to the first recommendation unit 112 of the first feedback recipient feedback module 11 via a second recommendation unit 112A of the second feedback recipient feedback module 11A. Thus, the first recommendation unit 112 may convert recommendation data from each recommender to records of recommendation information which are in turn sent to the system operation module 12. That is, the user and each recommender can send records of recommendation information to the system operation module 12 directly or indirectly via the first feedback recipient feedback module 11. Thus, the number of recommenders is increased and the number of the first feedback recipient feedback module 11 connected to the system operation module 12 is also increased. The number of recommenders associated with the user is increased greatly and in turn the number of the first feedback recipient feedback modules 11 is greatly increased.

The first recommendation unit 112 sets a count of records of recommendation information to be reached in a set period of time prior to sending feedback information to the system operation module 12. Thus, both the user and each recommender desire to reach the set count of records of recommendation information in the set period of time. And in turn, it effects a feedback mechanism in the set period of time. That is, feedback time is based on the set period of time and in turn the user can expect to have a quick feedback.

The system operation module 12 can collect cash flow information. The cash flow information is converted to feedback money based on personal information. Also, the system operation module 12 can collect gift information and convert same to gifts based on the number of sent records of recommendation information respectively. Finally, the system operation module 12 sends the cash flow information to the cash flow module 13 and the gift information to the supply module 14 respectively. Thus, the cash flow module 13 pay feedback money to the user and the supply module 14 may give gifts to the user respectively. Both the user and each recommendation who recommends others to use the invention can have feedback money and gifts and the feedback money and the gifts are increased in proportion to the numbers of users and recommenders. That is, each user and each recommender can benefit from using the invention. And in turn, a great impetus is generated. As a result, more and more users and recommenders using the invention are benefitted without continuing to operate the invention. A maximum feedback effect is thus brought about.

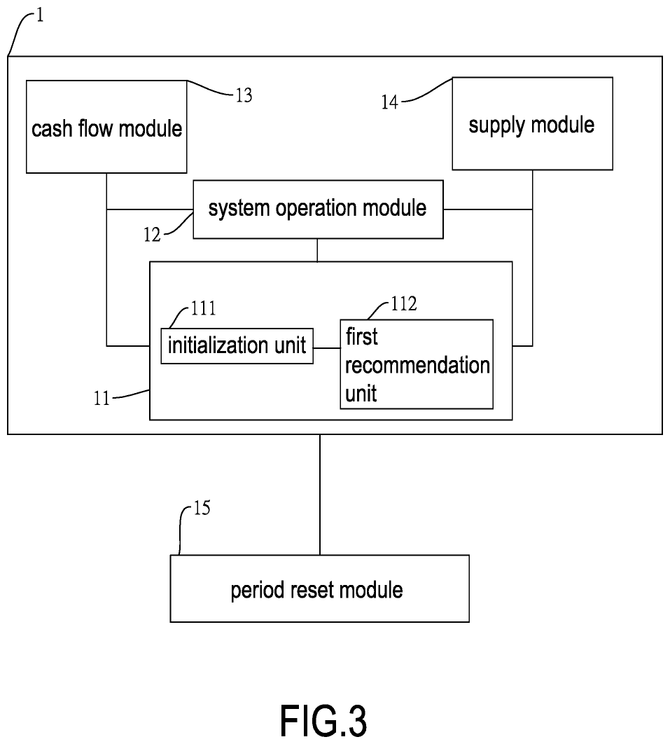

Referring to FIG. 3, a period reset module 15 is incorporated into the business feedback system 1 of the invention. As shown, the period reset module 15 is connected to the business feedback system 1. The period reset module 15 may set a period of time prior to inactivating the business feedback system 1. After the set period of time has lapsed, the business feedback system 1 resumes operation.

The period of time set by the period reset module 15 is 12 weeks. After 12 weeks have passed after using the invention, the period reset module 15 inactivates the invention. All operation information stored in the system operation module 12 will be reset when the business feedback system 1 resumes operation. This can prevent feedback from becoming excessively large. In brief, feedback is calculated and paid to the users and the recommenders at the end of 12-week period. Next 12-week period will be a new start of the invention.

Referring to FIGS. 1 to 2 again, in another configuration of the invention a user may invite another recommender to join the invention and once the recommender joins the invention the recommender can invite another potential recommender to use the initialization unit 111 to input personal data. Fee is shared by the two recommenders. At this time, the user can input personal data of both recommenders into the first recommendation unit 112. The input data is converted to two records of recommendation information which are in turn sent to the system operation module 12. The system operation module 12 converts the number of the records of recommendation information to cash flow information which is then sent to the cash flow module 13, and to gift information which is then sent to the supply module 14 respectively. The cash flow module 13 pays feedback money to the user and the supply module 14 gives gifts to the user respectively. The system operation module 12 also sends feedback promotion information of potential recommenders to the cash flow module 13 and the supply module 14 respectively. And in turn, the cash flow module 13 pays feedback money to the recommender and the supply module 14 gives gifts to the recommender respectively.

When the numbers of the recommenders and potential recommenders sending the recommendation information via the second recommendation 12 have reached the set count respectively, the system operation module 12 sends cash flow information to the cash flow module 13 and gift information to the supply module 14 respectively. And in turn, the cash flow module 13 pays feedback money to the user and the supply module 14 gives gifts to the user respectively.

The recommender may invite a second person, a third person, etc. (i.e., potential recommenders) to join the invention or any potential recommender invites another person to join the invention. If any potential recommender agrees, the potential recommender may input personal data into the initialization unit 111, and input records of recommendation information of the second person, the third person, etc. To the second recommendation unit 112A.

After the system operation module 12 has received the records of recommendation information and the number of received records of recommendation into has reached a set count, the system operation module 12 sends cash flow information to the cash flow module 13 and gift information to the supply module 14 respectively. And in turn, the cash flow module 13 pays feedback money to the user and the supply module 14 gives gifts to the user respectively.

The system operation module 12 converts the records of recommendation information sent from the first recommendation unit 112 to cash flow information and gift information based on a specific expression respectively. The cash flow module 13 pays feedback money to the user and the supply module 14 gives gifts to the user respectively. The system operation module 12 also sends feedback promotion information of potential recommenders to the cash flow module 13 and the supply module 14 respectively. And in turn, the cash flow module 13 pays feedback money to the recommender and the supply module 14 gives gifts to the recommender respectively. The recommender and potential recommender may send records of recommendation information via the second recommendation unit 112A. After the number of records of recommendation information has reached a set count, the system operation module 12 sends cash flow information to the cash flow module 13 and gift information to the supply module 14 respectively. And in turn, the cash flow module 13 pays feedback money to the user and the supply module 14 gives gifts to the user respectively. The potential recommender may input records of recommendation information of the second person, the third person, etc. To the second recommendation unit 112A. After the system operation module 12 has received the records of recommendation information and the number of received records of recommendation has reached a set count, the system operation module 12 sends cash flow information to the cash flow module 13 and gift information to the supply module 14 respectively. And in turn, the cash flow module 13 pays feedback money to the user and the supply module 14 give gifts to the user respectively. The total number of records of recommendation information of the users, the recommenders and the potential recommenders is greater than the number of records of recommendation information sent to the first recommendation 12 by a single user. And in turn, the cash flow module 13 pays feedback money to the user and the supply module 14 gives gifts to the user respectively. A great feedback effect is brought about.

In practice, the business feedback system of the invention may be inoperable if a user is dead. An inheritor of the user may receive feedback money paid by the cash flow module 13 or gifts given by the supply module 14 for a period of time. In detail, the system operation module 12 may respectively send cash flow information to the cash flow module 13 and gift information to the supply module 14 based on the cash flow information and the gift information generated by the first feedback recipient feedback module 11 prior to the user's death. The cash flow module 13 may pay feedback money to the inheritor and the supply module 14 may give gifts to the inheritor respectively for a period of time.

The invention has the following advantages and benefits in comparison with the conventional art:

Low risk includes zero risk, success guarantee, low cost, great benefit and short period. The cash flow module may refund the paid fee to the user if the recommendation does not send four records of recommendation information in a set period of time. There is no loss for the user, i.e., very low risk.

Continuous gifts given and feedback money paid (i.e., double benefit). A user may invite many recommenders to join the invention and each recommender may invite other potential recommenders to join the invention. A recommendation associated with the recommender and a recommendation associated with the user are interconnected. The total number of records of recommendation information associated with a user is increased greatly due to continuous recommendation. And in turn, feedback money is paid and gifts are given continuously.

Short period including low cost, great benefit, short period of time, fixed period and reliable expectation. The recommendation sends feedback information to the system operation module if the count of sent records of recommendation information has been reached in a set period of time. Either a user or a recommender may try to reach that goal. And in turn, a feedback mechanism is carried out. That is, feedback time is based on the set period of time and in turn the user may expect a desire feedback. This feedback is quick, can be expected, and is great.

Maximum feedback (i.e., accumulated feedback). Feedback information can be generated and sent to the system operation module if count of the sent records of recommendation information has been reached by a recommender or a user in a set period of time. As a result, accumulated feedback is fulfilled.

Automatic feedback after a period of time (i.e., system operation without organization). A user can easily operate the invention to recommend a recommender to use the invention so that the recommender may operate the invention in a similar way. The recommendation of the recommender and the recommendation of the user are interconnected. Thus, the total number of records of recommendation information associated with a user is increased greatly due to continuous recommendation of new recommenders. If the user does not do recommendation, a recommender still can have feedback by recommendation. Thus, the user still have feedback without operating the invention by himself or herself after operating the invention for a period of time.

Setting end of feedback (i.e., great economic cycle). The period reset module 15 can set a period of time as end of the invention (i.e., inactivating the business feedback system). After the set period of time has lapsed, the business feedback system resumes operation. All operation information stored in the system operation module will be reset when the business feedback system resumes operation. This can prevent feedback from becoming excessively large.

Health and common wealth. Gifts given by the cash flow module can be health food (preferred) or coupons. Thus, a user of the invention has health food. Also, a consumer has feedback money. Therefore, more users have a chance of having both health and wealth.

Maximum feedback. Recommendation information of users, recommenders and potential recommenders including feedback information and gift information can be sent to the cash flow module and the supply module via the system operation module respectively. And in turn, the cash flow module pays feedback money to the user and the supply module gives gifts to the user respectively.

Inheritor feedback is guaranteed. The business feedback system of the invention may be inoperable if a user is dead. An inheritor of the user may receive feedback money paid by the cash flow module or gifts given by the supply module for a period of time. The system operation module may respectively send cash flow information to the cash flow module and gift information to the supply module based on the cash flow information and the gift information generated by the first feedback recipient feedback module prior to the user's death. The cash flow module may pay feedback money to the inheritor and the supply module may give gifts to the inheritor respectively for a period of time.

Multifunction. The invention provides low price purchase, investment and financial management, saving and life insurance to users.

While the invention has been described in terms of preferred embodiments, those skilled in the art will recognize that the invention can be practiced with modifications within the spirit and scope of the appended claims.

What is claimed is:

1. A business feedback system comprising a first feedback recipient feedback module, a system operation module, a cash flow module, and a supply module wherein:
the first feedback recipient feedback module is connected to the system operation module, the cash flow module, and the supply module respectively and includes a first initialization unit for receiving personal data of a user, and a first recommendation unit connected to the first initialization unit for receiving recommendation data of the user;
the system operation module is connected to the first feedback recipient feedback module, the cash flow module, and the supply module respectively and configured to receive feedback information from the first recommendation unit and collect cash flow information or gift information which is sent to the cash flow module or the supply module;
the system operation module is configured to increase the number of the first feedback recipient feedback module connected thereto based on records of recommendation information;
the cash flow module is connected to the first feedback recipient feedback module and the system operation module respectively so that the cash flow module is configured to receive the cash flow information from the system operation module and send feedback money to the user of the first feedback recipient feedback module; and
the supply module is connected to the first feedback recipient feedback module and the system operation module respectively so that the supply module is configured to receive the gift information from the system operation module and send gifts to the user of the first feedback recipient feedback module.

2. The business feedback system of claim 1, wherein the gifts are health food or coupons.

3. The business feedback system of claim 1, further comprising a period reset module connected to the business feedback system for setting a predetermined period of time prior to inactivating the business feedback system, and wherein after the predetermined period of time has lapsed, the business feedback system resumes operation.

4. The business feedback system of claim 1, further comprising at least one second feedback recipient feedback module wherein the number of the at least one second feedback recipient feedback module is based on the number of the records of recommendation information, the at least one second feedback recipient feedback module is connected to the system operation module, the cash flow module, and the supply module respectively, and each of the at least one second feedback recipient feedback module includes a second initialization unit for receiving personal data of the user, and a second recommendation unit connected to the second initialization unit for receiving recommendation data of the user.
